(19) United States
(12) Patent Application Publication
(10) Pub. No.: US 2016/0134092 A1
(43) Pub. Date: May 12, 2016

(54) STRAIN RELIEF DEVICE FOR LOW FRICTION DROP CABLE

(71) Applicant: 3M INNOVATIVE PROPERTIES COMPANY, Saint Paul, MN (US)

(72) Inventors: Pierre Bonvallat, Cluses (FR); Marcelo Tamaki Ishuu, Campinas (BR); Felipe Salgado Rennó Bizarria, São José dos Campos (BR)

(21) Appl. No.: 14/896,574

(22) PCT Filed: Jun. 24, 2013
(86) PCT No.: PCT/US2013/047256

§ 371 Date: Dec. 7, 2015

(51) Int. Cl. H02G 15/007; F16L 3/12

(52) U.S. Cl. CPC H02G 15/007; F16L 3/1222

(57) ABSTRACT

The present invention relates to a strain relief device for use in a telecommunication enclosure. The exemplary strain relief device includes a bracket body base and a plurality of retention fingers extending from the bracket body base. Each of the plurality of retention fingers has a series of slots that define a plurality of tie down points for securing a drop cable at a plurality of points along one of the plurality of retention fingers. Each of the plurality of retention fingers has one of a chicane configuration, a serpentine configuration, comb configuration, and a rectangular configuration.

### FIELD OF INVENTION

The present invention relates to a device that provides high strain relief for drop cables with low friction coefficient and/or high and dense strain relief as well as easy handling and removing thereof.

### BACKGROUND OF INVENTION

Cables, such as telecommunication cables and electrical power distribution cables, are ubiquitous and used for distributing electrical power and all manner of data signals across vast networks. The majority of cables are electrically conductive cables (typically copper), although the use of optical fiber cables is growing rapidly in telecommunication systems as larger and larger amounts of data are transmitted. As cables are routed across power or data networks, it is necessary to periodically open, connect, or splice the cable so that power or data may be distributed to other cables or “branches” of the network. The cable branches may be further distributed until the network reaches individual homes, businesses, offices, and so on.

At each point where the cable is opened, it is necessary to protect the exposed interior of the cable. Commonly, a telecommunication enclosure, rack, or cabinet is used that has one or more entry portions through which cables enter and/or exit the enclosure. The capacity of the enclosure will vary depending upon the number of entry portions in the enclosure, the sizes of the entry portions, the number of cables entering the enclosure, and the sizes and number of cables passing through each entry portion will vary.

Often, strain relief needs to be provided for the cables entering these types of enclosure to prevent external forces exerted on the cables from affecting the connecting points disposed within the enclosure.

WO 2010/102657 discloses a cable bracket that provides strain relief to a fiber optic cable installed in a fiber optic cable management system. The strain relief device comprises a single piece base body and at least one clamping element, wherein the base body comprises at least one through hole for guiding at least one fiber optic cable and extending from a front side of the base body to a rear side of the base body, wherein a header part having at least one slit is disposed on the rear side of the base body and at least one deflecting element is disposed at an outer surface of the base body, wherein the clamping element is releasably connected to the base body.

US 2010/0092147 discloses an optical fiber cable retention device to be inserted into cable retention structures or slots disposed in a wall of a fiber distribution box. The optical fiber cable retention device includes a body having first and second opposing portions and a hinge disposed therebetween to retain an optical fiber cable when the optical fiber cable retention device is placed in a closed position. The first and second body portions are engageable with one another about the hinge. At least one of the first and second body portions includes a flexible wall portion configured to provide a retention force to an outer jacket of the fiber cable. At least one of the first and second body portions includes a strength member retention area having one or more structures configured to engage a strength member of the optical fiber cable. The optical fiber cable retention device also includes a latching mechanism to secure the device in the closed position.

CLEC's (competitive local exchange carriers) and ILEC's (incumbent local exchange carriers) desire a means of securing and protecting small diameter telecommunication cables and/or drop cables from damaging external forces such as external tensile forces or external shear forces. Additionally, a design that is easier to use and compatible with industry standard mounting structures is desired in order to save training and installation time for the installers. Conventional strain relief devices have a single securing or tie down point.

However, these strain relief devices are insufficient for new low friction drop cables or other difficult to grip drop cable geometries utilized in some Fiber to The Home (FTTH) network deployments. In particular, low friction drop cables are the cable of choice in some deployments for indoor applications where the low friction feature of the drop cables facilitates installation through small conduits. Thus, a new style of strain relief device is needed to allow upgrading existing products as well as to use in new enclosures for FTTH deployments where low friction cable or other difficult to grip cables are used.

### SUMMARY OF THE INVENTION

The present invention relates to a strain relief device for use in a telecommunication enclosure. The exemplary strain relief device includes a bracket body base and a plurality of retention fingers extending from the bracket body base. Each of the plurality of retention fingers has a series of slots that define a plurality of tie down points for securing a drop cable at a plurality of points along one of the plurality of retention fingers. Each of the plurality of retention fingers has one of a chicane configuration, a serpentine configuration, comb configuration, and a rectangular configuration.

In one aspect of the present invention, the strain relief device can be used for both strain and improved handling of low friction drop cables or other difficult to grip cable geometries. The plurality of tie down points on each retention fingers enables these types of drop cables to be gripped more securely with simple fastening members such as cable ties than can be achieved with conventional strain relief devices.

Additional features and advantages will be set forth in the detailed description which follows, and in part will be readily apparent to those skilled in the art from that description or recognized by practicing the embodiments as described herein, including the detailed description that follows, the claims, as well as the appended drawings.

### BRIEF DESCRIPTION OF THE DRAWINGS

A more complete understanding of the present invention may be had by reference to the following detailed description when taken in conjunction with the accompanying drawings, wherein:

FIG. 1 is a perspective view of an optical fiber enclosure containing an exemplary strain relief device of the present invention;

FIG. 2 is an enlarged view of a retention finger of the strain relief device of FIG. 1 receiving at least two low friction cables;

FIG. 3 is a perspective view of the strain relief device of the present invention;

FIG. 4 is a bottom perspective view of the strain relief device of the present invention;

FIG. 5 is a perspective view of another embodiment of the strain relief device of the present invention, wherein the strain relief device has a flat visual configuration;

FIG. 6 is a perspective view of another yet embodiment of the strain relief device of the present invention, wherein the strain relief device has a U-shaped configuration;

FIG. 7 is a bottom perspective view of the strain relief device of FIG. 6, receiving a plurality of cables;

FIG. 8 is a cross-sectional view of the three retention fingers of FIG. 6, showing the top face and bottom face of the retention finger; and

FIGS. 9A-9D shows four views of possible drop cable arrangements on a retention finger in accordance with the current invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE INVENTION

Now reference will be made in detail to exemplary embodiments of the present invention that are illustrated in the accompany drawings, which illustrate specific embodiments in which the invention may be practiced. The illustrated embodiments are not intended to be exhaustive of all embodiments according to the invention. It is to be understood that other embodiments may be utilized and structural or logical changes may be made without departing from the scope of the present invention. Wherever possible, similar reference numbers will be used throughout the drawings to refer to the same or similar parts. The following detailed description, therefore, is not to be taken in a limiting sense, and the scope of the present invention is defined by the appended claims.

Fiber to The Home network deployments are selecting application of low friction drop cables including Low Friction FRP Drop cables such as are available from Furukawa Electrical Co., Ltd. or Sumimoto Corporation. The low friction drop cables can be used in premises installations because of the benefits of the small size and low friction features of these drop cables which facilitate installation of small conduits commonly used to route cables within or along walls or ceilings of a building. However, the use of this type of drop cable creates a need to provide sufficient strain relief in fiber apparatus (i.e., boxes, enclosures, racks, frames, etc.) at the ends of the low friction drop cable. The exemplary strain relief device, disclosed herein, provides for the necessary holding power, for these low friction drop cables. In addition, the exemplary device can be readily retrofitted into existing fiber apparatus at a generally low price point.

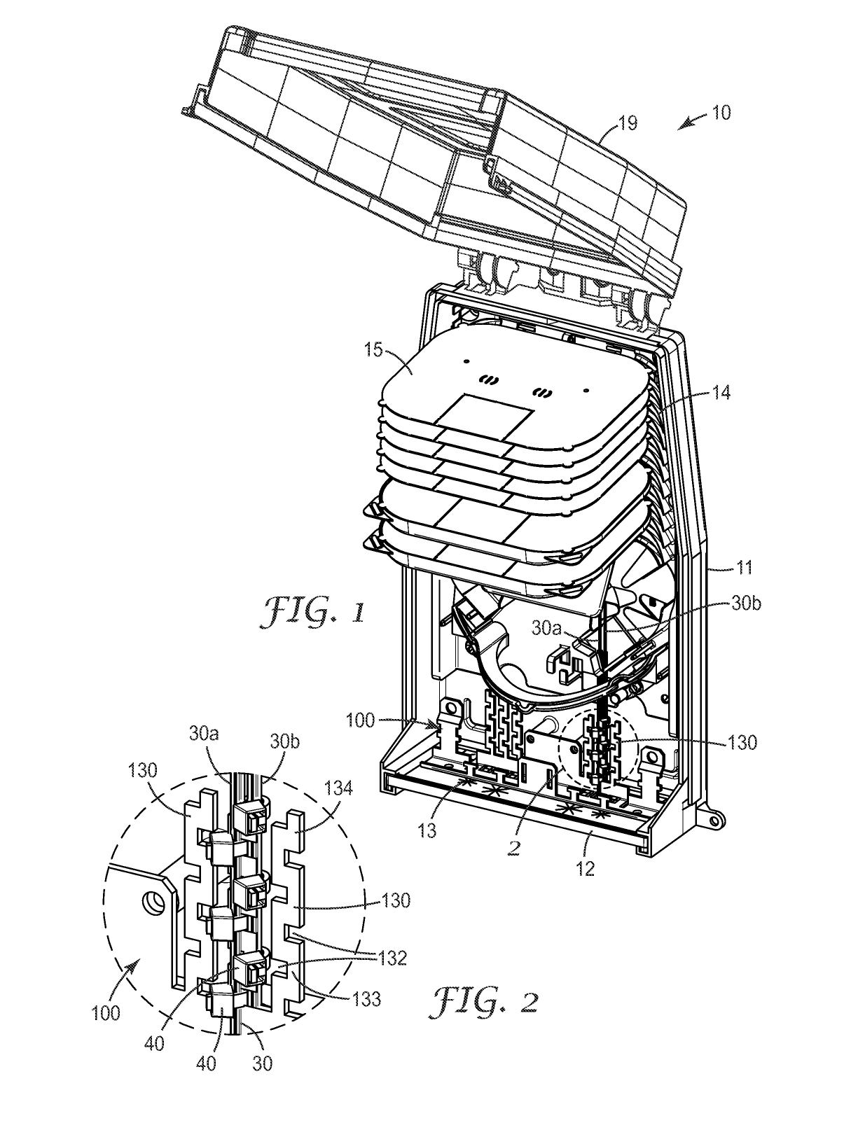

With reference to FIGS. 1-4, the preferred embodiment of strain relief device of the present invention is shown.

FIG. 1 shows an exemplary strain relief device 100 mounted in the optical fiber enclosure 10, such as Optical Fiber Multi-Dwelling Box available from 3M Company, as an illustrative application. Enclosure 10 provides a housing to hold the interconnection point(s) between the distribution cables and the drop cables. The exemplary enclosure can include a bottom portion 11 and a cover portion 19 hingedly attached to the base portion. The cover portion can be opened to provide access to the interior of the enclosure and close to provide environmental protection to the optical components disposed therein.

Enclosure 10 is configured with a plurality of distribution line ports 13 and a plurality of drop line ports (not shown) disposed in a bottom side wall 12 of the enclosure. Each drop line port can be configured to accept a plurality of optical fiber drop cables (note: two drop cables are shown in FIG. 1) such as a low friction drop cable. In an exemplary aspect, each drop line port can accommodate between one and four drop cables.

In the exemplary aspect, Enclosure 10 includes a plurality of splice trays 15 that are pivotally attached to fiber organizer 14. The splice trays can be configured to hold either fusion or mechanical splices that join the fibers in the distribution fiber to the fiber(s) in the drop cables. In an alternative aspect, the enclosure can contain an optical fiber patch panel (not shown) that is configured for use with preterminated distribution and drop cables. In yet another aspect, the enclosure can include an optical splitter(s) attached to one or more fibers in the distribution cables on one side of the optical splitter and a plurality of optical fiber drop cables attached to the second side of the optical splitter such that the signals from a single distribution fiber can be transmitted to a plurality of end users.

Strain relief device 100 shown in FIG. 1 has a generally linear configuration that can be used to secure each of the drop cables leaving the enclosure, as well as the distribution cables entering the enclosure. In an exemplary aspect, strain relief device 100 can extend along the bottom wall adjacent to the distribution line ports 13 and a plurality of drop line ports. In an alternative aspect, multiple smaller strain relief devices (not shown) can be used wherein the smaller strain relief devices support the drop cables leaving the enclosure through only a portion of the drop cable ports. In an alternative embodiment, the exemplary strain relief device can have a bent configuration such as when the drop cable ports are disposed in an arc in the side wall of the enclosure or any other configuration so long as the strain relief device is disposed suitably close to the ports through which the drop cables pass.

As previously mentioned, enclosure 10 includes ports and an associated strain relief device 100 disposed on one wall of the enclosure. Enclosures can include ports disposed on a plurality of walls of the enclosure. Thus, enclosure embodiments that include ports and associated strain relief devices disposed on a plurality of walls of the enclosure are considered to be covered within the present disclosure.

FIG. 2 shows an enlarged view of a portion of strain relief device 100 showing three retention fingers 130 that can be used to strain relieve a plurality of drop cables 40 (e.g. low friction FRP drop cables). For example, two drop cables are secured to the middle retention finger at a plurality of tie down points. In the exemplary aspect shown in FIG. 2, each drop cable is secured to the middle retention finger by three cable ties 40. Additional details will be discussed below.

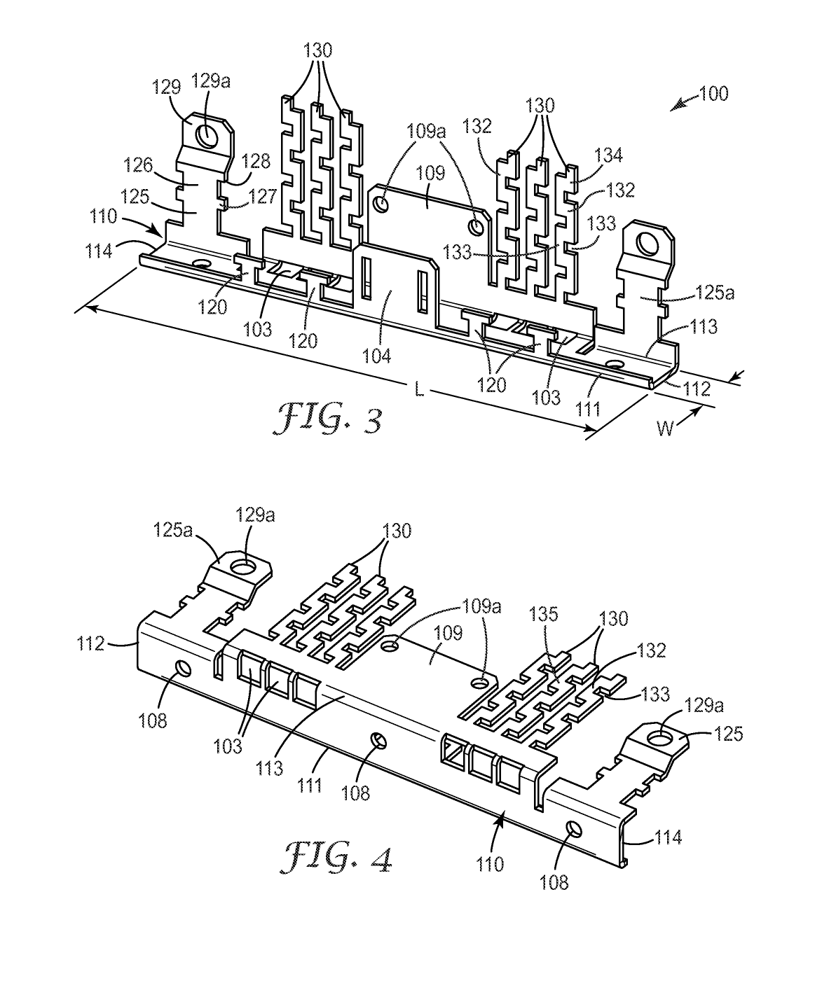

FIG. 3 shows an exemplary strain relief device 100 which includes a bracket body base 110. The bracket body base 110 can have a rectangular shape having two longitudinal edges (first edge 111, third edge 113 and two transverse edges (second edge 112 and forth edge 114). The bracket body base 110 can be characterized by a length, L, defining an elongated base extending in a linear direction parallel to the longitudinal edges of the bracket body base and a width, W, parallel to the transverse edges of the bracket body base. While bracket body base 110 is being described as having a rectangular shape, the bracket body base can have other geometric shapes as required by the port configuration of the enclosure into which it will be placed. Thus the shape of the bracket body base should not be seen as limiting. The bracket body base 110 can have a length, L, of at least 20 mm up to the width of the closure into which it will be installed and a width, W, of at least than 2 mm.

Bracket body base 110 can have one or more mounting holes 108 disposed therethrough to allow the bracket body base to be secured to the bottom wall 12 of enclosure 10 by mechanical fasteners. In addition, bracket body base 110 can further include mounting portion 109 extending upward from the bracket body base having mounting holes 109a for mounting bracket body base 110 to enclosure.

In addition, bracket body base 110 can include a locking plate 104 extending upward from the bracket body base that is configured to accept a conventional lock (not shown) to enable the cover of the enclosure to be locked closed. The lock can be attached to the locking plate by mechanical fasteners.

In one exemplary aspect, bracket body base 110 can include one or more cable passages 103. The cable passages are configured to allow drop cables to pass through the bracket body base so that the drop cables can be disposed along either face 134, 135 of the retention finger 130 as shown in FIGS. 3 and 4. Each of the faces 134, 135 of each retention finger is configured to receive at least one drop cable. The drop cables can be secured on the retention finger 130 through a tie down point 132 disposed along the opposite long sides of the retention fingers (see FIG. 2).

The strain relief device 100 can include a plurality of cable retainer members 120 extending from the bracket body base 110 along at least one of the longitudinal edges. For example, cable retainer members 120 extend from the bracket body base 110 along first edge 111 as shown in FIG. 3. In an exemplary aspect, the cable retainer members 120 can gave a T-shape to allow a drop cable to be secured to the cable retainer member by a fastening member (e.g. by a hose clamp, a cable tie or other fastening means) such that the crossbar of the cable retainer members prevents the fastening member from slipping off the cable retainer member.

The strain relief device 100 can include also at least one main cable retaining member 125 extending from the bracket body base 110 along at least one of the longitudinal edges. For example, main cable retaining members 125, 125a extend from the bracket body base 110 along third edge 113 as shown in FIG. 3. The main cable retaining member can include a central tie down portion 126 having one or more tabs 127 or flanges 128 extending laterally therefrom to retain a cable fastener and prevent it from slipping off the main cable retaining member. In addition, the main cable retaining member can include a tab portion 129 having a hole 129a to allow installation of a conventional strength member securing bracket.

In addition, strain relief device 100 can include at least one retention finger 130 extending perpendicularly from the bracket body base 110 along at least one of the longitudinal edges. For example, two groups of three retention fingers 130 extend from the bracket body base 110 along third edge 113 as shown in FIG. 3. Each retention finger defines a plurality of tie down points 132 for one or more drop cables. In an exemplary aspect, the retention fingers provide a plurality of tie down points for each drop cable secured to them.

As can be seen in FIGS. 2-4, each retention finger 130 of the strain relief device 100 of the present invention has a chicane configuration, a serpentine configuration, a comb configuration or a rectangular configuration. Each retention finger 130 has a series of alternating slots 133 disposed along the two long edges of the retention finger. Each slot 133 can be sized to allow securing of a drop cable to the retention finger by wrapping a cable tie (for example cable tie 30 shown in FIG. 2) or other cable fastening means therethrough and defining the tie down points 132 on each retention finger.

Referring to FIGS. 1-4, for example, a first drop cable 30a can be passed through the cable passage hole 103 disposed adjacent to the top face 134 of the retention finger 130 and secured by wrapping with a cable tie 40 in each tie down point 132 of that retention finger. Thus, drop cable 30a is secured to the retention finger at three tie down points by three cable ties on the left side of the central retention finger shown in FIG. 2. A second drop cable 30b can be passed through the cable passing hole 103 disposed adjacent to the top face 134 of the same retention finger and can be secured by wrapping with a cable tie in each tie down point on the right hand side of the same retention finger such that the second drop cable is disposed parallel to the first drop cable on the same face of the same retention finger. Securing each drop cable at a plurality of discrete tie down points allows even low friction drop cables to be secured without slipping.

In an exemplary aspect, strain relief device 100 can be formed as a single integral part such as a stamped and bent piece of sheet metal or injection molded plastic part. In an alternative aspect, the strain relief device 100 can be fabricated in a multiple pieces that are assembled together by tack welding or an adhesive prior to installation in an enclosure.

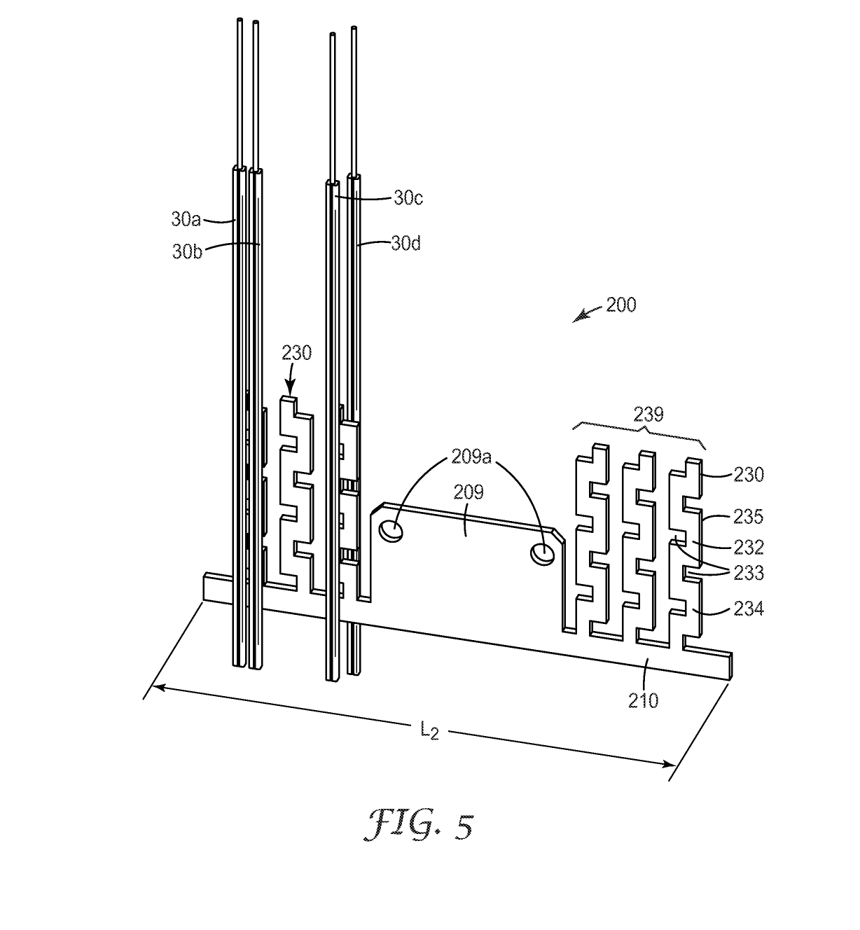

FIG. 5 shows an alternative embodiment of a strain relief device 200 in accordance with the present invention. Strain relief device 200 includes a bracket body 210 with a length, L₂, not smaller than 20 mm, extending in a linear direction and defining a flat portion. The bracket body 210 can include mounting holes 209a through its surface of a mounting portion 209 for mounting bracket body within a communications enclosure. At least one retention finger 230 can extend upward from the bracket body 210. The retention finger can include a series of slots 233 disposed in an alternating arrangement on either side of retention finger 230 as shown in FIG. 5 to give the retention finger a serpentine-like shape. Alternatively, the series of slots can be arranged on the same side of the retention finger to give the retention finger a comb-like shape. The slots define a plurality of tie down points 232; each tie down point disposed at the base of the slot opposite the slots open end. Each slot is configured to accommodate a fastening member such as a cable tie. The fastening members are positioned in the slots to prevent sliding along the length of the retention finger. The number of slots on each retention finger can vary depending on the holding force needed as well as on the type of drop cable to be held. Low friction drop cables may require more tie down points that other conventional drop cables although the shape and size of the drop cable may also favor additional tie down points.

Strain relief device 200 includes two sets 239 of three retention fingers 230 disposed on either side mounting portion 209. The number of sets of retention fingers as well as the number of retention fingers within each grouping can be considered a matter of design choice and should not be seen as limiting the scope of the present disclosure. The retention fingers 230 can have a chicane configuration, a serpentine configuration, a comb configuration or a rectangular configuration and when having a plurality of retention fingers, and each retention finger can be spaced along the width of the exemplary strain relief device.

The slot 233 on each retention finger can have a minimum width to allow wrapping of cable tie around the tie down point 232 and the drop cable being secured to that retention finger.

Each retention finger 230 extending from the flat bracket body 210 has a top face 233 (i.e. the exposed face in FIG. 5) and a bottom face 235 (facing the page in FIG. 5). In an exemplary aspect two drop cables can be secured to each retention finger. The drop cables can be disposed in a side-by-side arrangement on the same face of a given retention finger or can be disposed on opposite faces of the retention finger as shown for drop cables.

For example, in operation the installer can directly tie wrap the first drop cable 30a with one or more cable ties (not shown) on the top face 234 on the left side of retention finger 230a and the second drop cable 30b can be secured with one or more cable ties on the top face on the right side of the retention finger parallel to the first drop cable. Alternatively, drop cable 30c can be secured with one or more cable ties on the top face 234 on the left side of retention finger 230c and another drop cable 30d can be secured with one or more cable ties on the bottom face 235 of the same retention finger.

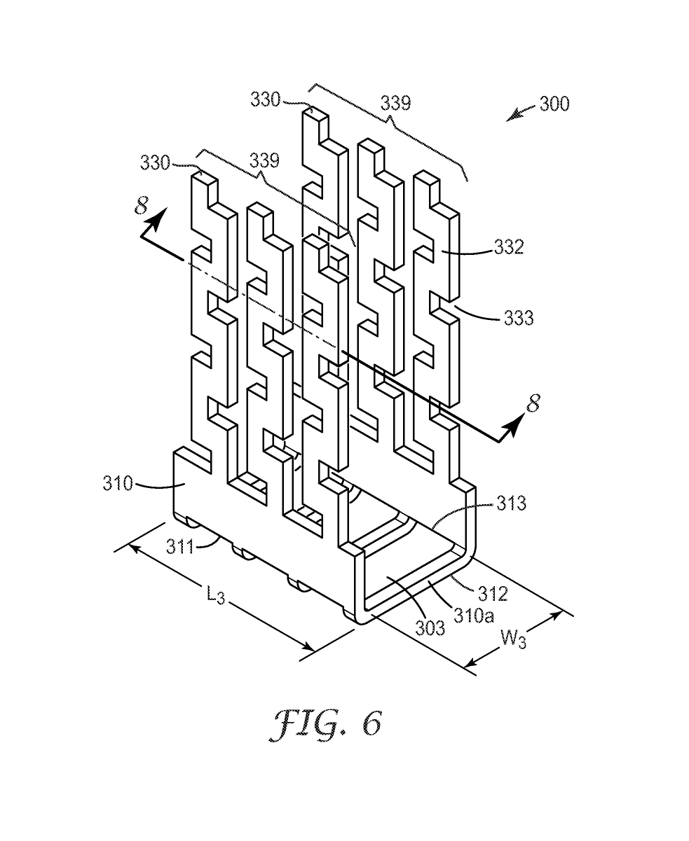

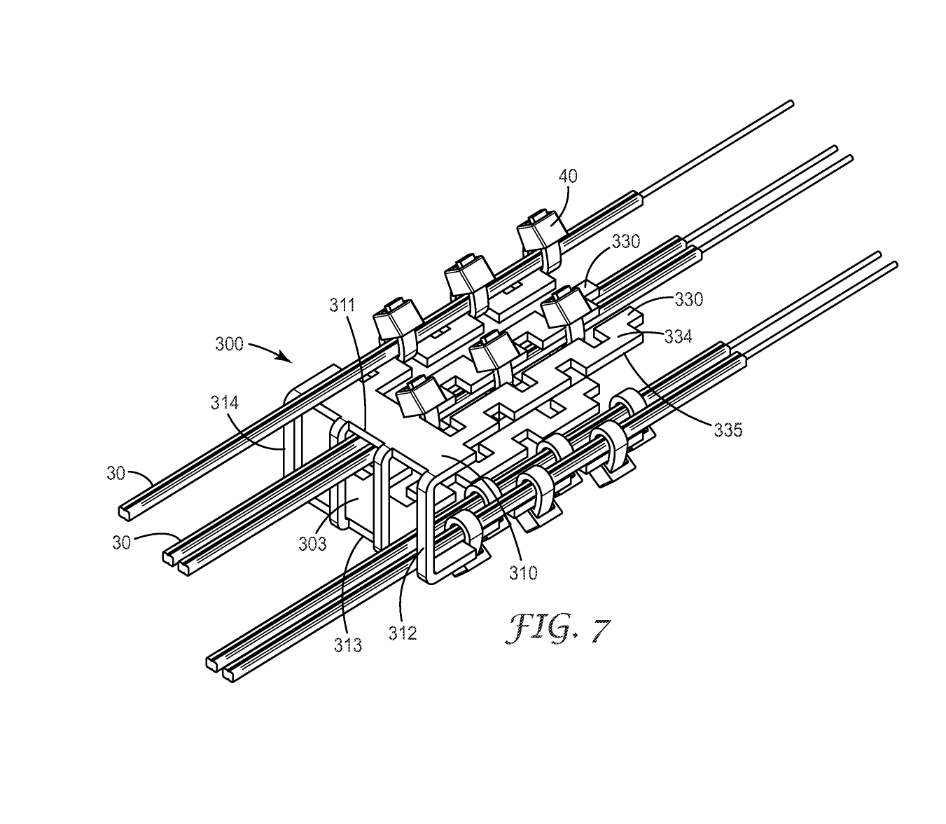

FIGS. 6 and 7 show yet another embodiment of strain relief device of the present invention, wherein the strain relief device 300 includes a U-shaped bracket body 310. The U-shaped bracket body 310 includes a base 310a can have a rectangular shape having two longitudinal edges (first edge 311, third edge 313) and two transverse edges (second edge 312 and forth edge 314). The bracket body base 310a can be characterized by a length, L₃, defining an elongated base extending in a linear direction parallel to the longitudinal edges of the base and a width, W₃, parallel to the transverse edges of base. While bracket body base 110 is being described as having a rectangular shape, the bracket body base can have other geometric shapes as required by the port configuration of the enclosure into which it will be placed. Thus, the shape of the bracket body base should not be seen as limiting.

Two sets 339 of retention fingers 330 extend upward from the base 310a of the bracket body 310 along each longitudinal edge of the base (i.e. first edge 311 and third edge 313). Each set of retention fingers is shown as having three separate retention fingers spaced along the length, L₃, of strain relief device 300.

U-shaped bracket body 310 includes at least one cable passage 303 through the bottom of base 310a between the two sets 339 of retention fingers 330. The cable passage is configured to allow drop cables to be routed between the two sets of retention fingers such that the drop cables can be secured to the inside faces of the retention fingers. In addition, drop cables can be routed along and secured to the exterior faces of the retention fingers of strain relief device 300. Thus, each face (334, 335) of each retention finger can receive at least one drop cable, said drop cable being secured to the same retention finger at tie down points 332.

Each retention finger 330 can include a series of slots 333 disposed in an alternating arrangement on either side of retention finger 330 as shown in FIG. 6 giving the retention finger a serpentine-like shape. Alternatively, the series of slots can be arranged on the same side of the retention finger to give the retention finger a comb-like shape. The slots define a plurality of tie down points 332; each tie down point disposed at the base of the slot opposite the slots open end. Each slot is configured to accommodate a fastening member such as a cable tie.

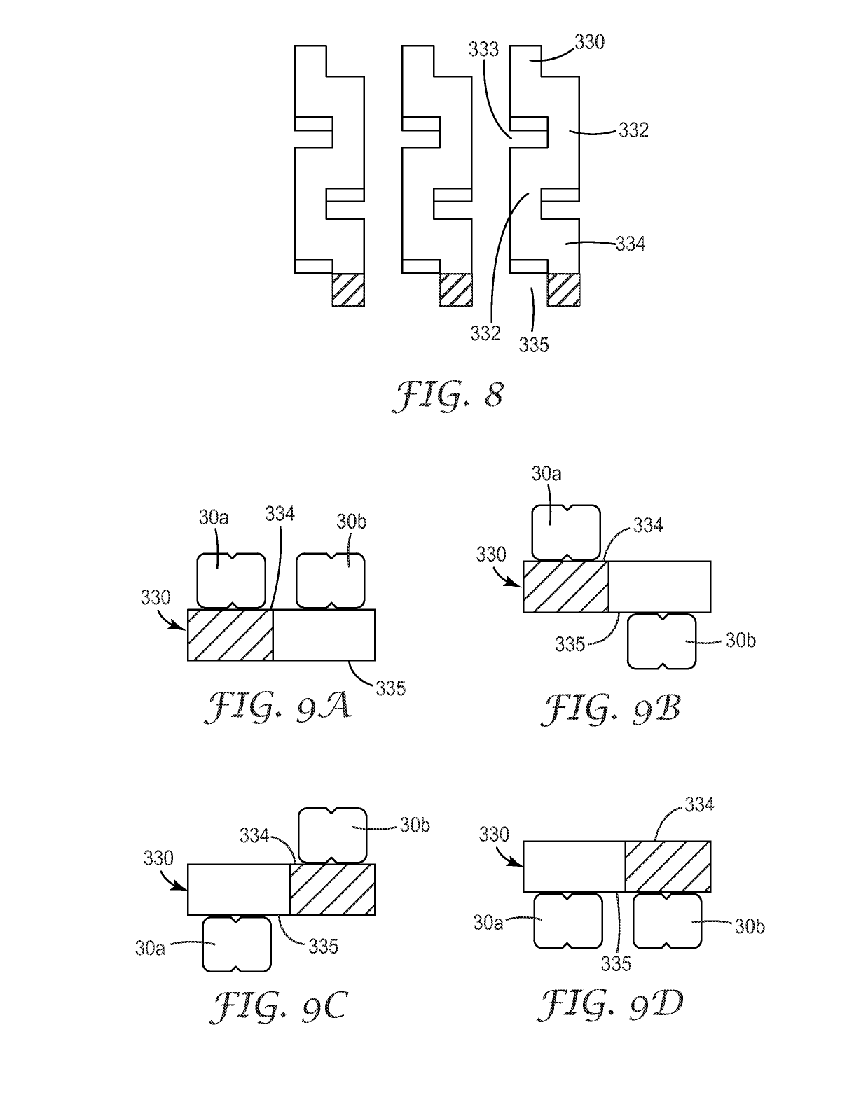

Referring to FIGS. 7-9, for example, an installer can wrap a first drop cable 30a with a cable tie (not shown) at each tie down point on the top face 334 of retention finger 330 and a second drop cable 30b can be wrapped with a cable tie at each tie down point located on the bottom (opposite) face 335 of the same retention finger by passing it through the cable passing hole 303 through the bracket body base of the exemplary strain relief device as shown in FIG. 9B and 9C. Alternatively, the second drop cable can be secured on the same face (i.e. top face 334 in FIG. 9A or bottom surface 335 in FIG. 9D) of retention finger 330 so that it lies adjacent to the first drop cable, being both tie wrapped with a cable tie in each respective tie down points on the same face of the retention finger.

The exemplary strain relief devices described herein can be formed as a single integral part such as a stamped and bent piece of sheet metal or injection molded plastic part. In an alternative aspect, the strain relief device can be manufactured in a multiple pieces that are assembled together by tack welding or an adhesive prior to installation in an enclosure.

In addition, the exemplary strain relief devices described herein can be used for both strain and improved handling of low friction drop cables or other difficult to grip drop cable geometries. The plurality of tie down points on each retention fingers enables these types of drop cables to be gripped more securely with simple fastening members such as cable ties than can be achieved with conventional strain relief devices. The slots on the retention fingers prevent the fastening members from sliding along the retention fingers thus eliminating a problem seen if one simply tries to add additional ties down points to a conventional strain relief device.

It should be understood that embodiments disclosed herein are merely examples with each one incorporating certain benefits of the present disclosure, and it is not intended to be exhaustive or to limit the invention to the precise form described. Examples were chosen and described in order to best explain practical applications of the invention to thereby enable others skilled in the art to best utilize the invention. It will be apparent to those skilled in the art that various modifications or variations of preferred embodiments of the disclosure described herein can be made without departing from the scope and spirit of the invention as defined in the appended claims.

1. A strain relief device comprising:
a bracket body base, and
a plurality of retention fingers extending from the bracket body base, wherein each of the plurality of retention fingers has a series of slots that define a plurality of tie down points for securing a drop cable at a plurality of points along one of the plurality of retention fingers.

2. The strain relief device according to claim 1, wherein each of the plurality of retention fingers has one of a chicane configuration, a serpentine configuration, comb configuration, and a rectangular configuration.

3. The strain relief device according to claim 1, wherein the plurality of retention fingers are spaced apart along a longitudinal length of the bracket body base.

4. The strain relief device according to claim 1, wherein the slots between each retention finger have a sufficient width to accommodate a fastening member which is secured around the drop cable at the tie down points.

5. The strain relief device according to claim 1, the fastening member is a cable tie.

6. A strain relief device according to claim 1, wherein bracket body base has mounting holes extending therethrough for mounting the strain relief device in a telecommunication enclosure.

7. A strain relief device according to claim 1, wherein bracket body has a mounting portions extending upward from the bracket body base that has a plurality of mounting holes for mounting the strain relief device in a telecommunication enclosure.

8. A strain relief device according to claim 1, wherein the retention fingers are arrange in sets, wherein each set includes a plurality of retention fingers.

9. A strain relief device according to claim 1, wherein the strain relief device comprises a plurality of sets of retention fingers and wherein the sets of retention fingers are arranged linearly along a longitudinal length of the bracket body base.

10. A strain relief device according to claim 1, wherein the strain relief device comprises at least two sets of retention fingers disposed on opposite sides of the bracket body base.

11. A strain relief device according to claim 1, wherein bracket body base includes cable passages to allow the passage of drop cables through the bracket body base.

12. A strain relief device according to claim 10, wherein bracket body base includes cable passages to allow the passage of drop cables through the bracket body base and between the at least two sets of retention fingers.

13. The strain relief device according to claim 1, wherein the bracket body base is comprised of a linear plate.

14. The strain relief device according to claim 1, wherein the bracket body base is a U-shaped bracket body.

15. The strain relief device according to claim 1, further comprising a plurality of cable retainers members extending from the bracket body base.

16. The strain relief device according to claim 1, further comprising at least one main cable retaining members extending from the bracket body base.

17. A strain relief device according to claim 1, wherein each retention finger is configured to hold two drop cables.

18. A strain relief device according to claim 13 wherein each retention finger includes a two faces wherein the two drop cables are mounted one of the two faces of the retention finger.

19. A strain relief device according to claim 13 wherein each retention finger includes a two faces wherein the each of the two drop cables is mounted on one of the two faces of the retention finger.
